(19) United States
(12) Patent Application Publication
(10) Pub. No.: US 2011/0242438 A1
(43) Pub. Date: Oct. 6, 2011

(54) LIGHTING UNIT, DISPLAY DEVICE, AND TELEVISION RECEIVER

(75) Inventor: Hirokazu Mouri, Osaka-shi (JP)

(73) Assignee: SHARP KABUSHIKI KAISHA, Osaka-shi, Osaka (JP)

(21) Appl. No.: 13/139,306

(22) PCT Filed: Sep. 10, 2009
(86) PCT No.: PCT/JP2009/065810

§ 371 Date: Jun. 13, 2011

(30) Foreign Application Priority Data
Dec. 19, 2008 (JP) 2008-324135

(51) Int. Cl. G02F 1/13357; F21V 29/00; H04N 3/14

(52) U.S. Cl. 348/790; 362/294; 362/97.1; 349/61; 348/E03.016

(57) ABSTRACT

A lighting unit 12 in accordance with the present invention includes: a light source 17; a chassis 14 having an opening 14b that allows light from the light source 17 to exit; an optical sheet 15 disposed over the opening 14b of the chassis 14 so as to enclose a space between the chassis 14, the optical sheet 15 configured to transmit the light from the light source 17; a sealing members 30, 31 securing the optical sheet 15 to the chassis 14 in a sealing manner; and an internal-pressure adjusters 35, 45 configured to adjust the internal pressure in the space enclosed by the chassis 14 and the optical sheet 15.

### TECHNICAL FIELD

The present invention relates to a lighting unit, a display device having the lighting unit, and a television receiver having the lighting unit.

### BACKGROUND ART

A liquid crystal display device is a typical one of display devices with non-light-emitting optical elements. The display device includes a display panel and a backlight unit arranged behind the display panel (for example, see Patent Document 1).
Patent Document 1: Japanese Unexamined Patent Application Publication No. 2006-215512

### Problem to be Solved by the Invention

The backlight unit disclosed in Patent Document 1 includes a chassis, a diffuser plate, and a light source (fluorescent lamps). The light source is disposed in a space defined by the chassis and the diffuser plate. Document 1 discloses a technology for keeping optical sheets from becoming wrinkled and, further, for preventing foreign matters from entering the optical sheets from the periphery thereof or a gap between the backlight unit and a holder for the display device.

While wrinkle in the diffuser plate or in the optical sheets may decrease the brightness uniformity, warping of the diffuser plate or of the optical sheets also decrease the brightness uniformity. One of main causes of the warping is thermal expansion due to a difference in temperature between the front surface and the rear surface of the sheets. When the light source of the backlight unit in Document 1 turns on and the temperature in the chassis rises, the optical sheet may warp. Such warping of the optical sheet may cause brightness non-uniformity, resulting in reducing the quality of the liquid crystal display device.

### DISCLOSURE OF THE INVENTION

The present invention was accomplished based on the above circumstances, and its object is to provide a lighting unit in which optical sheets including a diffuser plate is less likely to warp and brightness non-uniformity is less likely to occur. Another object of the present invention is to provide a high-quality and reliable display device including the lighting unit. Still another object of the present invention is to provide a high-quality and reliable television receiver including the display device.

### Means for Solving the Problem

In order to solve the problem, a lighting unit in accordance with the present invention includes: a light source; a chassis having an opening that allows light from the light source to exit; an optical sheet disposed over the opening of the chassis so as to enclose a space between the chassis, the optical sheet being configured to transmit the light from the light source; a sealing member securing the optical sheet to the chassis in a sealing manner; and an internal-pressure adjuster configured to adjust an internal pressure in the space enclosed by the chassis and the optical sheet.

Because the optical sheet of the lighting unit is secured to the chassis in the sealing manner, the internal pressure rises when the light source is turned on and the temperature rises. Accordingly, the optical sheet is less likely to warp toward the light source. As a result, an image of the light source (an area right above the light source is bright and other areas are dark) is less likely to be visually recognized.

Furthermore, because the lighting unit includes the internal-pressure adjuster, an excessive rise in internal pressure due to a rise in temperature is less likely to occur, and the optical sheet is less likely to warp away from the light source.

In accordance with the present invention, with the sealing member and the internal-pressure adjuster, the warping of the optical sheet toward the light source or away from the light source can be properly prevented or reduced. Therefore, the lighting unit in which the brightness non-uniformity is less likely to occur can be provided.

### BRIEF DESCRIPTION OF THE DRAWINGS

FIG. 1 is an exploded perspective view illustrating general configuration of a television receiver of an embodiment of the present invention;

FIG. 2 is an exploded perspective view illustrating schematic configuration of a liquid crystal display device included in the television receiver;

FIG. 3 is a sectional view illustrating schematic configuration of the liquid crystal display device;

FIG. 4 is a sectional view illustrating engagement relation between lamp clips and a chassis includes in the liquid crystal display device of this embodiment;

FIG. 5 is an explanatory view illustrating an aspect of passing a wire through the chassis;

FIG. 6 is an explanatory view illustrating a configuration of a sealing member and an internal-pressure adjuster;

FIG. 7 is an explanatory view illustrating a modification of the internal-pressure adjuster;

FIG. 8 is an explanatory view illustrating a modification of the internal-pressure adjuster;

FIG. 9 is an explanatory view illustrating a modification of the internal-pressure adjuster;

FIG. 10 is an explanatory view illustrating an aspect of operation of the internal-pressure adjuster shown in FIG. 9; and

FIG. 11 is an explanatory view illustrating the aspect of operation of the internal-pressure adjuster shown in FIG. 9.

### BEST MODE FOR CARRYING OUT THE INVENTION

An embodiment in accordance with the present invention will hereinafter be described with reference to the drawings.

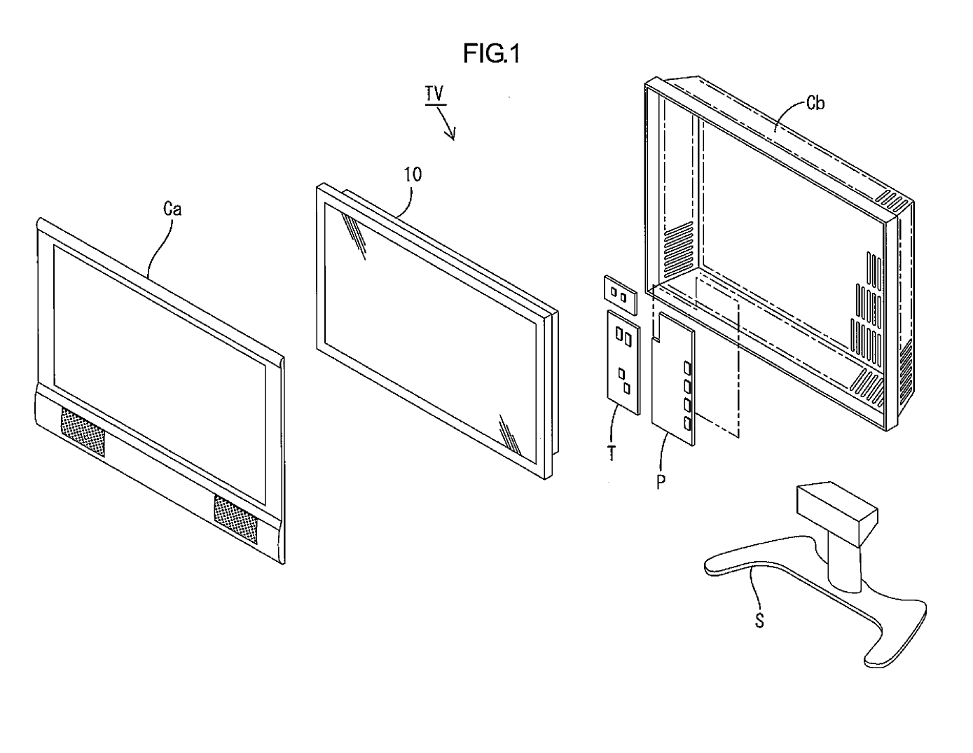

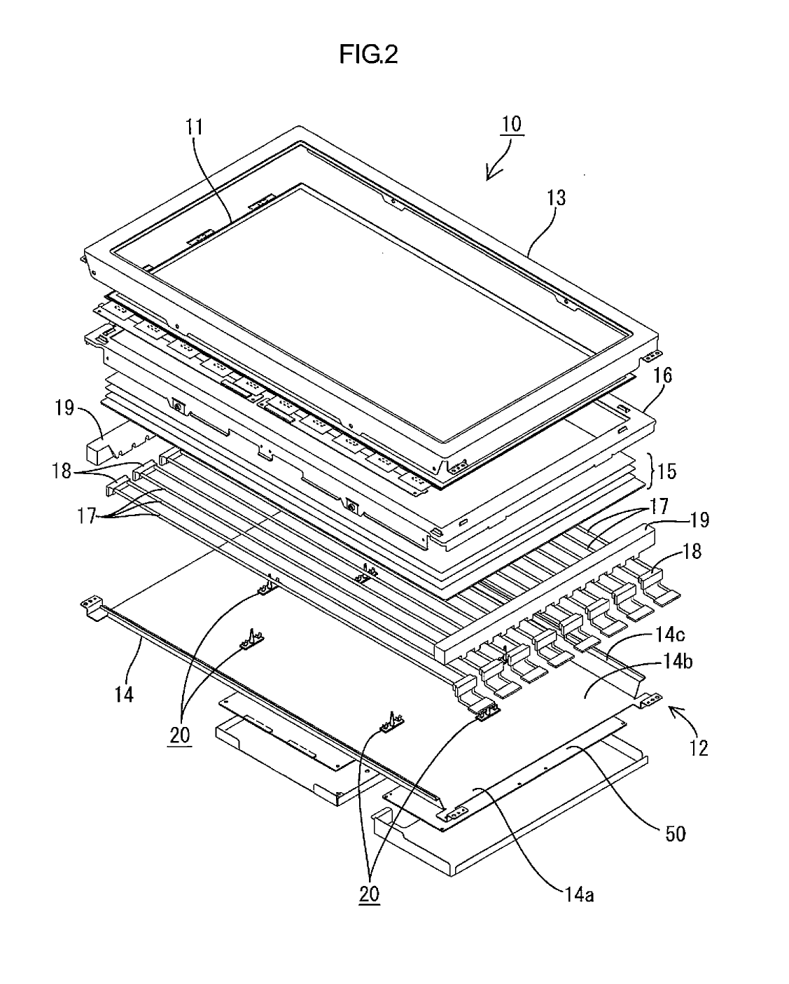

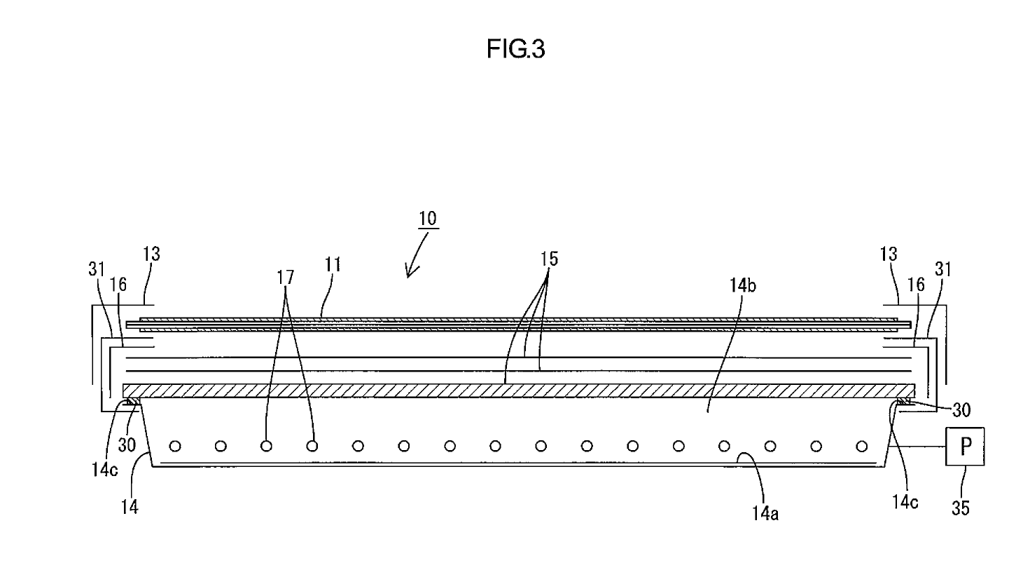

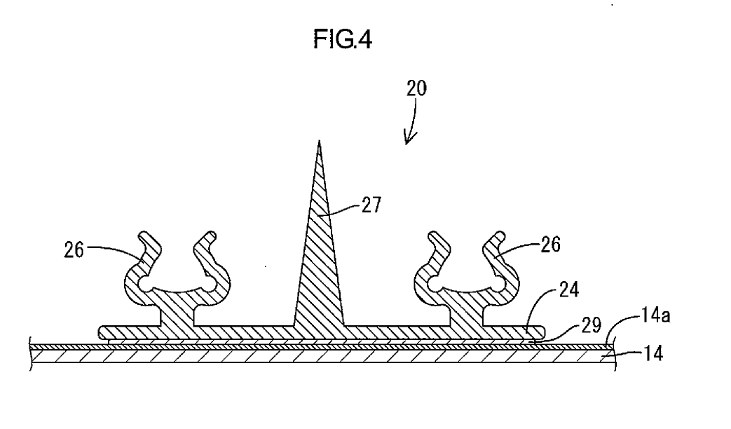

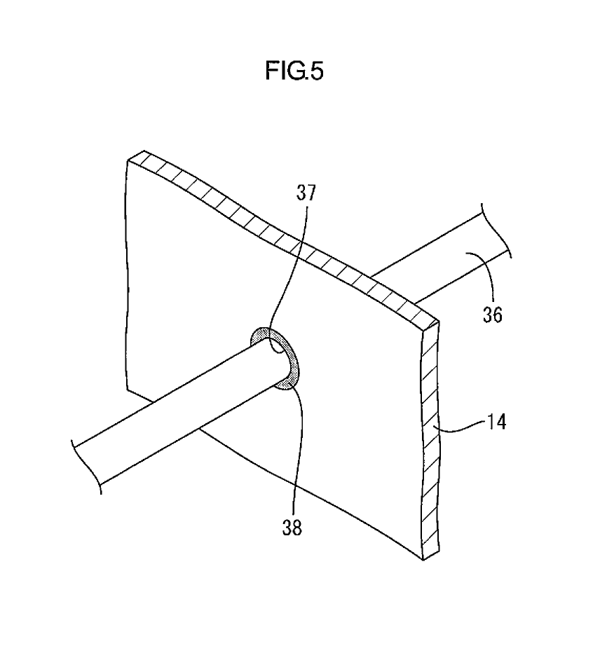

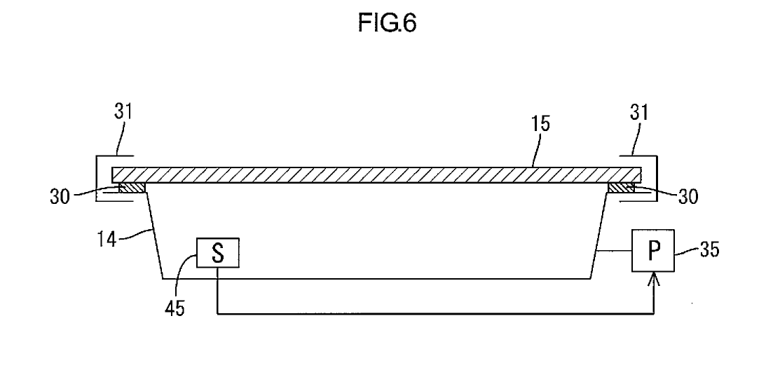

FIG. 1 is an exploded perspective view illustrating general configuration of a television receiver of this embodiment. FIG. 2 is an exploded perspective view illustrating schematic configuration of a liquid crystal display device that the television receiver includes. FIG. 3 is a sectional view illustrating schematic configuration of the liquid crystal display device. FIG. 4 is a sectional view illustrating engagement relation between lamp clips and a chassis that the liquid crystal display device of this embodiment includes. FIG. 5 is an explanatory view illustrating an aspect of passing a wire through the chassis. FIG. 6 is an explanatory view illustrating configuration of a sealing member and an internal-pressure adjuster.

As illustrated in FIG. 1, the television receiver TV of this embodiment includes the liquid crystal display device (a display device) 10, a front cabinet Ca, a rear cabinet Cb, a power source P, a tuner T, and a stand S. The liquid crystal display device 10 is held between the front cabinet Ca and the rear cabinet Cb. The liquid crystal display device (a display device) 10 has a landscape rectangular overall shape. As illustrated in FIG. 2, the liquid crystal display device 10 includes a liquid crystal panel 11, which is a display panel, and a backlight unit (a lighting unit (a lighting unit for a display device)) 12, which is an external light source. The liquid crystal panel 11 has a rectangular shape in planar view. The liquid crystal panel 11 and the backlight unit 12 are held in one piece by a bezel 13 etc.

The liquid crystal panel 11 includes a pair of glass substrates bonded together with a predetermined gap therebetween and with liquid crystals sealed between the substrates. Switching elements (e.g., TFTs), pixel electrodes, etc. are arranged on one of the glass substrates. The switching elements are connected to source lines and gate lines that are perpendicular to each other. The pixel electrodes are connected to the switching elements. A counter electrode, color filters including color sections such as R, G, B in a predetermined arrangement, a common electrode, etc. are arranged on the other glass substrate.

Next, the backlight unit 12 will be explained. As illustrated in FIGS. 2 and 3, the backlight unit 12 is a so-called direct backlight unit, having a plurality of linear light sources (cold cathode tubes (tubular light source) 17 are used in this embodiment) each extending along a panel surface (a display surface) and directly facing the backside surface of the panel surface of the liquid crystal panel 11.

The backlight unit 12 includes a backlight chassis (a chassis) 14, a plurality of optical sheets 15 (a diffuser plate, a diffuser sheet, a lens sheet, and a reflection type polarizing sheet, in that order from the bottom side in the figure), a frame 16, a cold cathode tubes (light sources), holders 18 made of rubber (e.g. silicon rubber), lamp holders 19, and lamp clips 20. The backlight chassis 14 is made of metal and has a substantial box shape with the upper side open. The optical sheets 15 are secured to the backlight chassis 14 over the opening 14b. The frame 16 holds the optical sheets 15 on the backlight chassis 14. The cold cathode tubes 17 are accommodated in the backlight chassis 14. The holders 18 hold both ends of the cold cathode tubes 17. Each lamp holder 19 collectively covers the cold cathode tubes 17 and the holders 18. The lamp clips 20 securely hold the cold cathode tubes 17 on the backlight chassis 14. In the backlight unit 12, an optical sheets 15 side with respect to the cold cathode tubes 17 is a light exit side.

Each cold cathode tube 17 has an elongated tubular shape. The cold cathode tubes 17 (sixteen tubes in FIG. 1) are accommodated in the backlight chassis 14 with the length (the axis) along the long sides of the backlight chassis 14. On the other hand, each lamp clip 20, which secures the cold cathode tubes 17 to the backlight chassis 14, has two light-source holders 26 and a support 27 on a plate 24 as illustrated in FIG. 4. The support 27 supports the optical sheets 15. The lamp clip 20 is made of synthetic resin (e.g. polycarbonate). The plurality of lamp clips 20 are secured to the backlight chassis 14 such that each cold cathode tube 17 is held at two or three different points along the length thereof. A reflector sheet 14a is provided on an inner surface side of the backlight chassis 14. The lamp clips 20 are attached to the reflector sheet 14a with double-sided adhesive tape 29.

The substantially box-shaped backlight chassis 14 is made of metal plate. The inner surface side (the light source side) of the backlight chassis 14 is provided with a light reflector surface formed by the light reflector sheet 14a. Including such a light reflector sheet 14a, the backlight chassis 14 can reflect the light emitted by the cold cathode tubes 17. The light reflector sheet 14a can be configured by, for example, a resinous sheet having light reflective characteristics.

An inverter board 50 for providing drive voltage to the cold cathode tubes 17 is mounted to an outer surface of the backlight chassis 14, i.e. in a side opposite from a side in which the cold cathode tubes 17 are disposed (in a side opposite from the light exit surface side). The inverter board 50 includes an inverter circuit that generates high-frequency voltage for lighting the cold cathode tubes 17. In particular, one-side high voltage driving method is applied for driving the cold cathode tubes 17 in this embodiment, with the inverter circuit connected to one sides of the cold cathode tubes 17. As illustrated in FIG. 5, power is supplied from the inverter board 50 through a power supply harness 36, which is passed through an insertion hole 37 in the backlight chassis 14. Specifically, in this embodiment, a rubber gasket 38 is disposed in the insertion hole 37 so as to seal the gap between the harness 36 and the insertion hole 37.

The optical sheets 15 are seated on sheet seating portions 14c of the backlight chassis 14 via rubber gaskets 30 (a sealing member). Clips (a clamp, the sealing member) 31 clamp the optical sheets 15 and the sheet seating portions 14c together with the rubber gasket 30 compressed, i.e. in a sealing manner. Specifically, the clips 31 hold the optical sheets 15 by clamping the backlight chassis 14 and the frame 16 together, while the rubber gasket 30 and the optical sheets 15 are held between the backlight chassis 14 and the frame 16 with the rubber gasket 30 compressed. With such configuration, the space enclosed by the backlight chassis 14 and the optical sheets 15 is hermetically sealed.

Furthermore, the internal pressure in the hermetically sealed backlight chassis 14 can be adjusted with a pump 35. In this embodiment, a pressure sensor 45 is provided in the backlight chassis 14 as illustrated in FIG. 6. The pressure sensor 45 measures a pressure value (pressure information), according to which the pump 35 operates as appropriate. Specifically, the pump 35 has a built-in controller (not shown). When the controller has determined based on the information from the pressure sensor 45 that the pressure in the backlight chassis 14 has risen, the controller operates the pump 35 to depressurize the backlight chassis 14. On the other hand, when the controller has determined based on the information from the pressure sensor 45 that the pressure in the backlight chassis 14 has dropped, the controller operates the pump 35 to pressurize the backlight chassis 14.

The above-described television receiver TV of this embodiment provides the following operational functions.

The television receiver TV includes the liquid crystal display device 10 having the backlight unit 12. The backlight unit 12 has the backlight chassis 14 and the optical sheets 15, which are secured to the backlight chassis 14 in a sealing manner. Therefore, when the cold cathode tubes 17 are turned on and the temperature rises, the internal pressure rises. Accordingly, the optical sheets 15 are less likely to warp toward the light source. As a result, images of the cold cathode tubes 17 (areas right above the cold cathode tubes 17 are bright while areas between the cold cathode tubes 17 are dark) are less likely to be visually recognized. Furthermore, because the backlight unit 12 includes the pump 35 and the pressure sensor 45 as the internal-pressure adjuster, excessive internal-pressure rise due to the rise in temperature does not occur, and thus the warping of the optical sheets 15 away from the cold cathode tubes 17 does not occur.

As stated above, because the backlight unit 12 of this embodiment includes the sealing member (the clips 30 and the rubber gaskets 31) and the internal-pressure adjuster (the pump 35 and the pressure sensor 45), the warping of the optical sheets 15 toward the cold cathode tubes 17 or away from the cold cathode tubes 17 can be properly prevented or reduced. Therefore, the backlight unit 12 (the lighting unit) is less likely to cause brightness non-uniformity. Therefore, the liquid crystal display device 10 and the television receiver both having the backlight unit 12 can provide display with uniform brightness and high quality.

While the above is an embodiment according to the present invention, the present invention is not limited to the embodiment described with reference to the drawings. For example, following embodiments are also included within the technical scope of the present invention. Furthermore, variations other than the following embodiments are also possible within the scope and spirit of the invention.

<First Modification of Internal Pressure Adjuster>

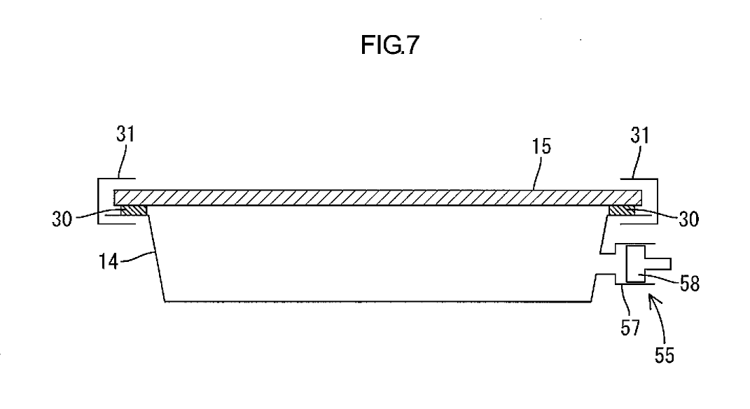

FIG. 7 is an explanatory view illustrating a modification of the internal-pressure adjuster.

An internal-pressure adjuster 55 illustrated in FIG. 7 includes a cylinder 57 and a piston 58. The cylinder 57 communicates with the space enclosed by the backlight chassis 14 and the optical sheets 15. The piston 58 is disposed in the cylinder 57 so as to relatively move in the cylinder 57 according to the pressure in the backlight chassis 14. In other words, as the pressure in the backlight chassis 14 rises, the piston 58 moves to right in the figure, i.e. away from the backlight chassis 14, so as to increase the volume between the backlight chassis 14 and the cylinder 57. On the other hand, when the pressure in the backlight chassis 14 drops, the piston 58 moves to left in the figure, i.e. toward the backlight chassis 14, so as to reduce the volume between the backlight chassis 14 and the cylinder 57.

This modification can also properly adjust the pressure in the space enclosed by the backlight chassis 14 and the optical sheets 15. Furthermore, this modification does not require the controller. As the piston 58 changes its position according to the pressure in the backlight chassis 14, the volume of the space changes under the constant pressure.

<Second Modification of Internal Pressure Adjuster>

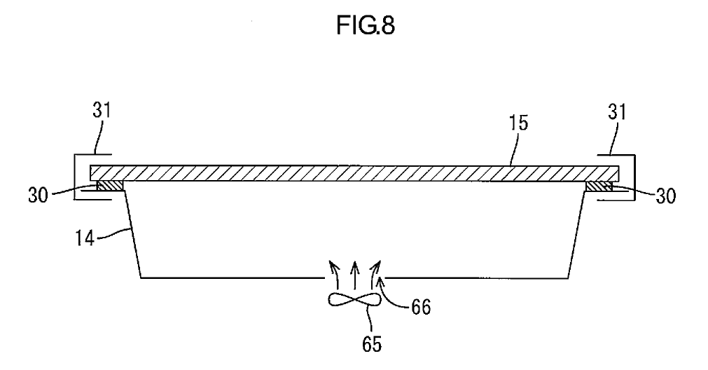

FIG. 8 is an explanatory view illustrating a modification of the internal-pressure adjuster.

The internal-pressure adjuster illustrated in FIG. 8 includes a sub-opening 66 and a fan 65. The space enclosed by the backlight chassis 14 and the optical sheets 15 has the sub-opening 66. The fan 65 sends air into the backlight chassis 14 through the sub-opening 66. In FIG. 8, the sub-opening 66 is illustratively defined in the center of a bottom surface of the backlight chassis 14.

Such configuration of sending air from the fan 66 into the backlight chassis 14 can also adjust the pressure in the backlight chassis 14.

<Third Modification of Internal Pressure Adjuster>

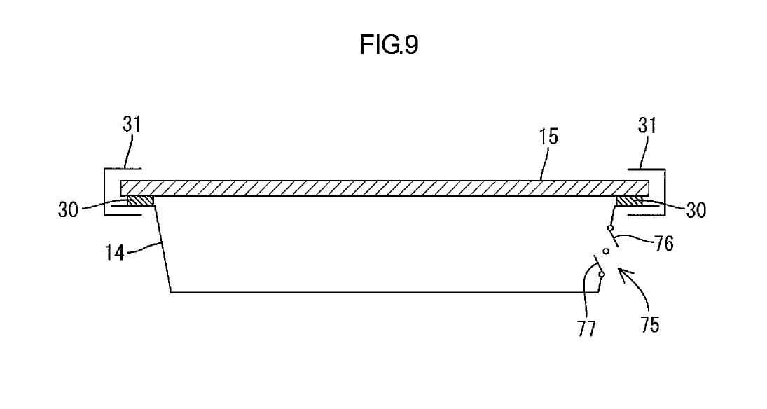

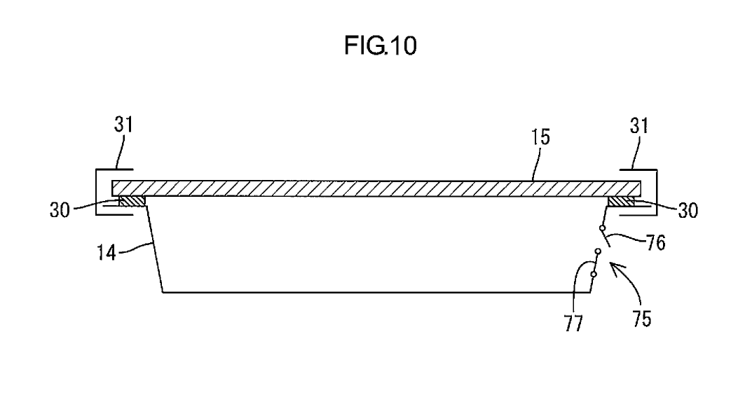

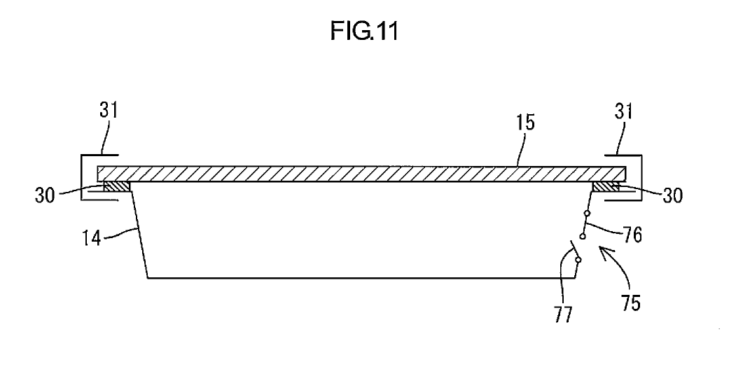

FIG. 9 is an explanatory view illustrating a modification of the internal-pressure adjuster. FIGS. 10 and 11 are explanatory views illustrating a manner of operating the internal-pressure adjuster.

The internal-pressure adjuster illustrated in FIG. 9 includes an on/off valve 75 provided in the backlight chassis 14. The on/off valve 75 includes a first valve 76 and a second valve 77. As illustrated in FIG. 10, the first valve 76 opens outward when the pressure in the backlight chassis 14 has risen. As illustrated in FIG. 11, the second valve 77 opens inward when the pressure in the backlight chassis 14 has dropped.

This configuration can also properly adjust the internal pressure in the space enclosed by the backlight chassis 14 and the optical sheets 15. In particular, this modification does not require the controller. As the on/off valve 75 switches the first valve 76 and the second valve 77 between open and closed, the internal pressure is adjusted.

<Other Modifications>

In the above-described embodiment, the sealing member that seals the gap between the backlight chassis 14 and the optical sheets 15 includes the rubber gasket 30 and the clips 31. The gap between the backlight chassis 14 and the optical sheets 15 can be sealed by applying adhesive between the backlight chassis 14 and the optical sheets 15.

In the above-described embodiment, the pump 35 has the built-in controller that controls operation of the pump 35 based on the pressure information from the pressure sensor 45. The controller may be provided separately from the pump 35.

In the above-described embodiment, the one-side high voltage driving method is illustratively applied for driving the cold cathode tubes 17. The above-described configuration can be adopted in the backlight unit 12 according to double-side high voltage driving method.

In the above-described embodiment, the cold cathode tubes 17 are illustrated as the light source. The present invention includes also lighting units that have light sources of the other types such as hot cathode tubes.

Furthermore, in the above-described embodiment, the TFTs are used as the switching elements of the liquid crystal display device. The present invention is applicable to liquid crystal display devices with switching elements (such as thin film diodes (TFDs)) other than the TFTs. The present invention is thus applicable not only to the color liquid crystal display device but also to black-and-white liquid crystal display devices.

Furthermore, while the liquid crystal display device is illustrated in the above-described embodiment, the present invention is applicable also to the other display devices (other than the liquid crystal display device) with backlight units.

1. A lighting unit comprising:
a light source;
a chassis having an opening that allows light from the light source to exit;
an optical sheet disposed over the opening of the chassis so as to enclose a space between the chassis, the optical sheet being configured to transmit the light from the light source;
a sealing member securing the optical sheet to the chassis in a sealing manner; and
an internal-pressure adjuster configured to adjust an internal pressure in the space enclosed by the chassis and the optical sheet.

2. The lighting unit according to claim 1, wherein the internal-pressure adjuster includes:
a pressure sensor configured to detect the pressure in the space enclosed by the chassis and the optical sheet; and
a pump configured to pressurize or depressurize the space enclosed by the chassis and the optical sheet based on pressure information from the pressure sensor.

3. The lighting unit according to claim 1, wherein the internal-pressure adjuster includes:
a cylinder that communicates with the space enclosed by the chassis and the optical sheet; and
a piston disposed in the cylinder so as to relatively move in the cylinder according to the pressure in the space.

4. The lighting unit according to claim 1, wherein the internal-pressure adjuster includes:
a sub-opening in the space enclosed by the chassis and the optical sheet; and
a fan configured to send air to the area through the sub-opening.

5. The lighting unit according to claim 1, wherein the internal-pressure adjuster includes an on-off valve configured to open and close according to the pressure in the space enclosed by the chassis and the optical sheet.

6. The lighting unit according to claim 1,
wherein the sealing member includes:
a gasket disposed between the chassis and the optical sheet; and
a clamp that clamps the chassis and the optical sheet together with the gasket compressed.

7. The lighting unit according to claim 1, wherein the sealing member includes adhesive disposed between the chassis and the optical sheet.

8. A display device comprising:
the lighting unit according to claim 1; and
a display panel configured to provide display by using light from the lighting unit.

9. The display device according to claim 8, wherein the display panel is a liquid crystal panel with liquid crystals.

10. A television receiver comprising the display device according to claim 8.
